(19) United States
(12) Patent Application Publication
(10) Pub. No.: US 2026/0010341 A1
(43) Pub. Date: Jan. 8, 2026

(54) VOICE ACTIVATED MULTIPLE FORMAT VIRTUAL ASSISTANT

(71) Applicant: Murat YILDIRIM, NEW ROCHELLE, NY (US)

(72) Inventor: Murat YILDIRIM, NEW ROCHELLE, NY (US)

(21) Appl. No.: 19/162,129

(22) PCT Filed: Aug. 14, 2023
(86) PCT No.: PCT/US2023/072170

§ 371 Date: Sep. 10, 2025

Related U.S. Application Data
(60) Provisional application No. 63/399,015, filed on Aug. 18, 2022.

(51) Int. Cl. G06F 3/16; G06F 9/451

(52) U.S. Cl. CPC G06F 3/167; G06F 9/453

(57) ABSTRACT

A voice activated multiple format virtual assistant enables a user to operate multiple virtual assistants (VA) from a single user facing interface (UFI) or network of UFIs disposed about the user's environment. The UFI includes means to access selective partitions of memory corresponding to individual and otherwise mutually exclusive VAs. Issuance of a wake word or other prompt signal, then, enables a user to receive multiple responses from different VAs through a single device without a user having to manually select between specific operating systems or interfaces.

### INCORPORATION BY REFERENCE

This nonprovisional patent application claims the benefit of U.S. provisional application No. 63/399,015, the entirety of which is incorporated herein by reference.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Voice activated virtual assistants are seen in the art. Typically, a branded standalone user-facing interface relays a prompt signal to connect over network with an operating system running voice recognition software to access a search engine, database, or other directories and executable files, in formats readable by the particular operating system, whereby a response is generated and relayed back to the consumer.

Examples of such voice accessible user-facing interfaces include Amazon's® Echo®, which runs the Alexa® virtual assistant; Apple® platform, which runs the Siri® virtual assistant on iOS®; Google® platform, which runs the Google Assistant® on Android® enabled devices; Microsoft® platform, which runs the Cortana® virtual assistant on Windows 10@ operating system, JAVA®, and, in some embodiments, Android®; and OpenAI's Chat GPT®, which run's on OpenAI's proprietary series of models. Each of these devices is branded and is pointed towards particular directories and data sets wherein branded software applications extract targeted data. For example, Cortana® accesses the Bing® search engine (Microsoft's® search engine) whereas Google Assistant® accesses Google®. ChaptGPT accesses across databanks to synthesize and articulate responses. Thus, modernly, users are presented with mutually exclusive options for virtual assistants, which are in turn typically accessed through mutually exclusive hardware. Use of one virtual assistant, then, typically preempts use of another.

What is needed is a voice activated multiple format virtual assistant, and a method for providing the same, that provides a user-facing interface able to connect a user with any virtual assistant without regard to particular, branded hardware, operating system, or software.

### FIELD OF THE INVENTION

The present invention relates to a voice activated virtual assistants generally, and more particularly, to a voice activated multiple format virtual assistant and method for presenting a user-facing interface that enables access to any virtual assistant called through a single device.

### SUMMARY OF THE INVENTION

The present voice activated multiple format virtual assistant, and accompanying method, has been devised to enable a user access to any virtual assistant when the appropriate wake word(s) or prompt signal is communicated to a single, user-facing interface (“UFI”). In an example embodiment contemplated herein, the UFI may be a faceplate installable to an outlet in a home or office wall, for example. Alternatively, the UFI may be a tabletop apparatus or other apparatus or, in some embodiments contemplated herein, integrated with other hardware, such as a smart television for example, or an automobile radio, or other household or consumer apparatuses suited for the purpose (such as a smart phone, tablet, or other device, for example). The UFI May further include embodiments utilizing existing microphones in existing hardware which are accessed and/or controlled and/or repurposed to operate with the present voice activated multiple format virtual assistant and method thereof. In other words, the UFI may consist of protocol operating in conjunction with such hardware as is required to enable the disclosure set forth herein. For example, the UFI may comprise an existing hard drive upon which software is executed, say, or a smart TV, for example, or other household smart device, appliance, apparatus, peripheral, or handheld or tablet, as case may be.

In an example embodiment contemplated herein, therefore, user speech is interpreted at the UFI. The UFI includes or accesses a microphone wherein audible signals are registered. When a prompt signal or “wake word” is processed, the UFI sends the signal over network to access the appropriate virtual assistant corresponding to and/or matched with the wake word discerned. The virtual assistant responds through the UFI, which, in some embodiments, includes at least one speaker (or, in other embodiments, other and/or additional means of rendering data sensible, such as, in some embodiments, a screen wherein the response is illustrated as words and/or graphics, for example).

The UFI, therefore, in an example embodiment contemplated herein, is disposed in network to access at least one memory wherein an application programming interface (“API”) translates between operating systems peculiar to each virtual assistant accessible through the UFI. The API may select the appropriate virtual assistant in response to the wake word or prompt signal (such as the depression of a button or selection of an icon on a touchscreen disposed on the UFI) and connect over network to the appropriate location, whether local or remote, for processing and responding to the voice command over the network.

In some embodiments contemplated herein, the UFI connects to a switch that routes the signal to associated partitions in memory, for example, or to separate memory, wherein partitioned, or separate operating systems, may respond to the signal for processing. In some embodiments contemplated herein, a docker is contemplated to enable selective installation of operating systems or direct drives dedicated to run specific operating systems and/or subscriptions whereby a user is enabled to connect to virtual assistants by installing, whether manually or electronically, particular partitions to memory. The docker may be connected to the UFI by means of a switch or other router to control traffic thereto and therefrom.

Thus, has been broadly outlined the more important features of the present voice activated multiple format virtual assistant so that the detailed description thereof that follows may be better understood and in order that the present contribution to the art May be better appreciated.

For better understanding of the voice activated multiple format virtual assistant, its operating advantages and specific objects attained by its uses, refer to the accompanying drawings and description.

### BRIEF DESCRIPTION OF THE DRAWINGS

### Figures

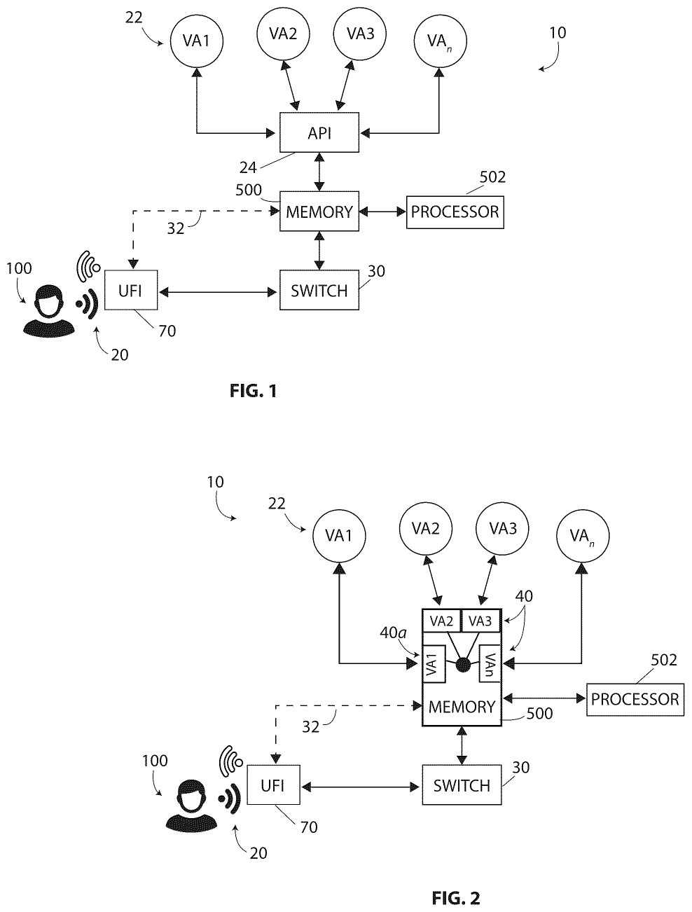

FIG. 1 is a diagrammatic view of an example embodiment.

FIG. 2 is a diagrammatic view of an example embodiment.

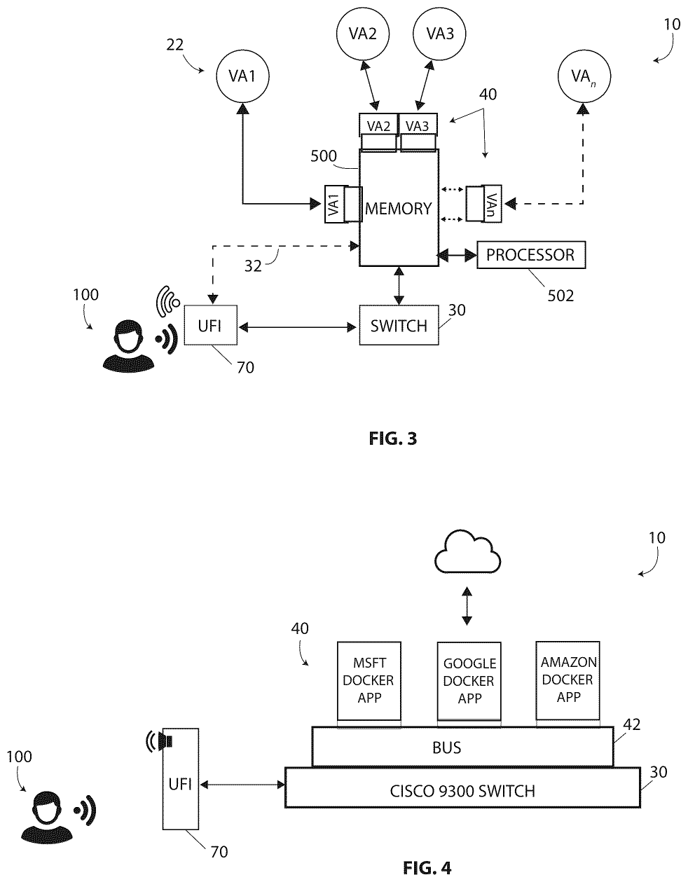

FIG. 3 is a diagrammatic view of an example embodiment.

FIG. 4 is a diagrammatic view of an example embodiment.

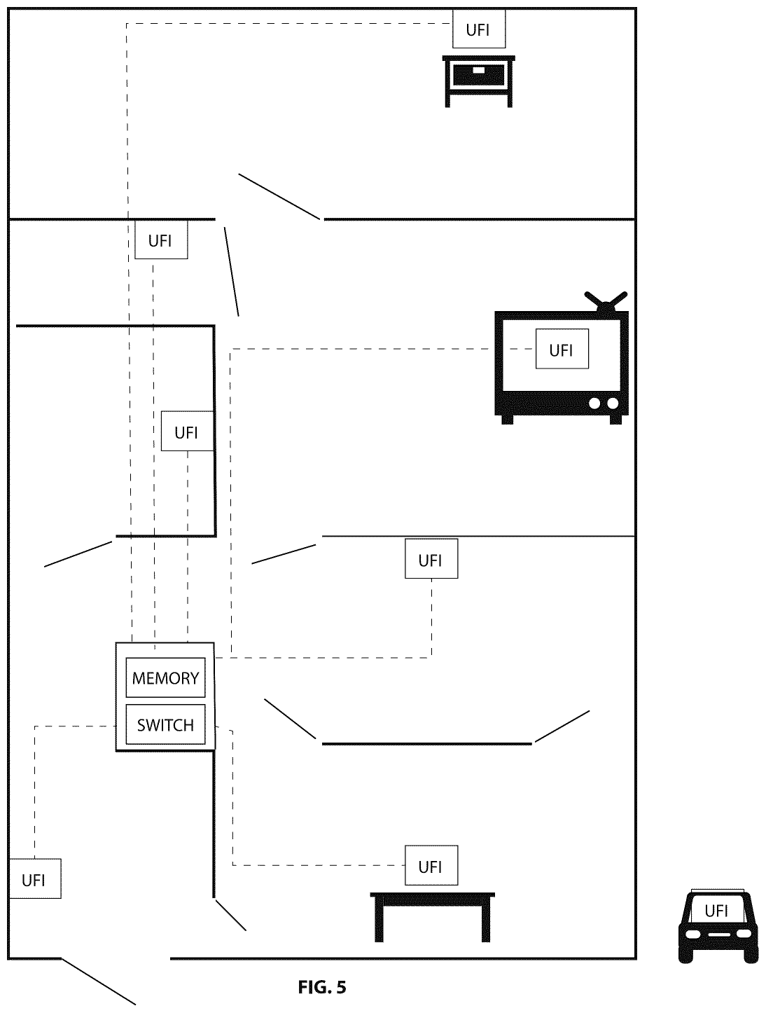

FIG. 5 is a diagrammatic view of an example embodiment wherein multiple UFIs are integrated into a user environment.

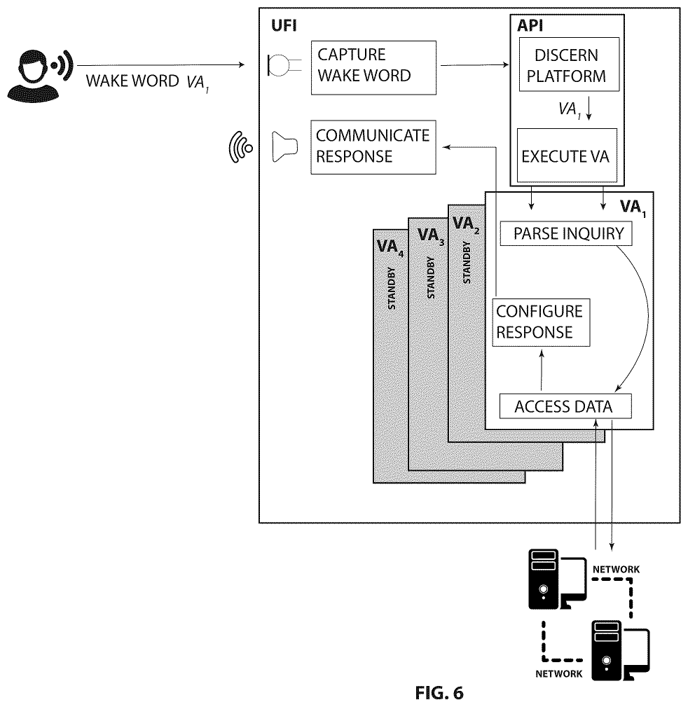

FIG. 6 is a diagrammatic view of an example embodiment wherein a prompt signal executes a particular one of a plurality of virtual assistants by action of an API discerning and attributing the wake word to access a particulate partition of memory and execute the corresponding VA.

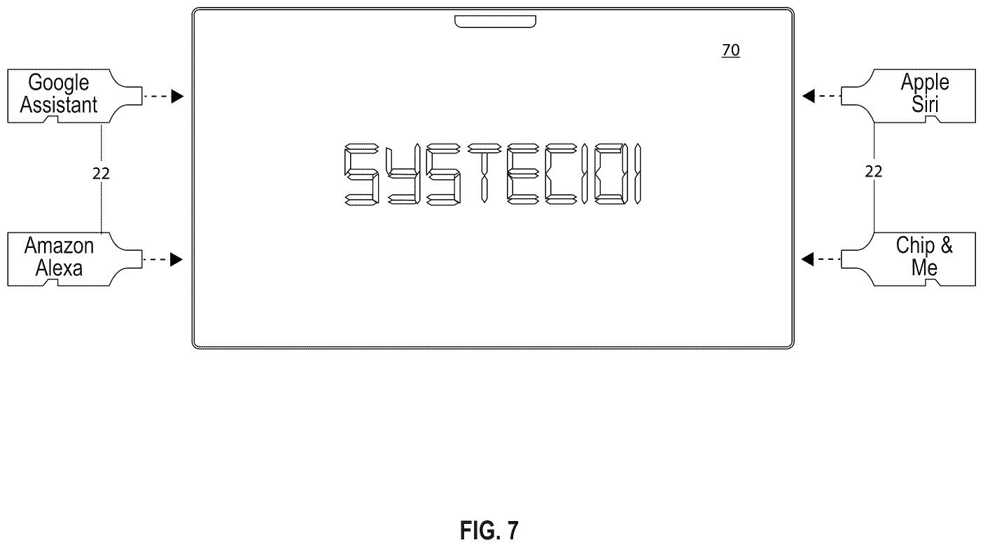

FIG. 7 is a front elevation view of an example embodiment having installable modules upon each of which a particular VA is executable.

### DETAILED DESCRIPTION OF THE DRAWINGS

Referring now to the accompanying drawings, simplified example embodiments of the present voice activated multiple format virtual assistant are depicted diagrammatically, to further exemplify and illustrate the inventive step set forth herein for contemplation among persons of ordinary skill in the art. It should be noted that the accompanying drawings are not intended to be limiting; rather, the metes and bounds of the invention as set forth herein comprise overall features as may be common to all embodiments, and/or be combined between any and all of the embodiments, and/or equivalently represented by other means, and/or varied within requisite scope as suggested by this disclosure and as interpretable according to the knowledge of persons of ordinary skill in the pertinent art, whereby the general intent and motivation of the invention should be applied to various alternative and exemplary embodiments as may emerge, and are not depicted, in contemplation of the same.

Referring now to FIG. 1, therefore, an example embodiment of the present voice activated multiple format virtual assistant 10 is illustrated in simplified form. User 100 issues a wake word or other prompt signal 20 (such as pressing a button or selecting an icon on a touchscreen associated with the UFI) which is received by UFI 70. UFI 70 may be actively listening, and when a speech pattern is recognized or matched to a particular waveform as representing a specific word or phrase, for example, or other prompt signal is discerned or sensed, the UFI 70 communicates with memory 500 to access one of a plurality of virtual assistants (“VAs”) 22. In this example embodiment, switch 30 is shown between UFI 70 and memory 500. However, as shown by data path 32, embodiments are contemplated wherein UFI 70 directly accesses memory 500 absent and/or bypassing switch 30.

Memory 500 and processor 502 operationally control API 24, which, in this example embodiment, effectuates communication with one of plurality of VAs 22 by translating prompt signal over network to access any one of plurality of VAs 22. Return of data from the selected VA 22 may likewise be translated through API 24.

Referring to FIG. 2, UFI 70 is disposed in operational communication with memory 500 and processor 502. In this example embodiment, memory 500 contains partitions 40 wherein individual operating systems and/or software applications enable selective communication with VAs 22 over network. Processor 502 and memory 500 access the appropriate partition 40 when prompted by matching the partition 40 with prompt signal 20. Thus, for example, when prompt signal 20 is matched to VA1, say, in this example embodiment, protocol is executed in partition 40a, whereby VA1 is accessed over network. In this example embodiment, partitions 40 may be created in memory 500 and specific protocols and/or operating systems installed therein to run applications for operative communication with each associated VA 22.

In this example embodiment shown, partitions 40 may be writable in memory 500 over network, whereby subscription and digital rights management (“DRM”) software may enable control and execution of applications peculiar to each partition 40. As such, a user may subscribe to a VA provider, write the partition to memory 500, install an application for operational communication with the VA 22, and then access and use the VA 22 all via network. In some or all embodiments contemplated herein, such partition 40 and/or installation and/or writing to memory 500 may, in some embodiments, be effectuated through the UFI 70 whereby memory 500 initially hosts means enabling recognition of prompt signals 20 to set up any of the plurality of VAs 22 automatically upon prompt by user 100.

Referring now to FIG. 3, plurality of partitions 40 may be disposed in memory hosted on separate drives or hardware insertable into hardware hosting memory 500, such as thumb drives, disks, solid state drives, or other storage media, whereby installation of any one of plurality of partitions 40 instantiates a partition and/or directory of memory, wherein an application hosted thereon enables operational communication with the associated VA 22. For example, VAn is shown ready for installation by physical insertion to memory 500. In this example embodiment, subscription to each VA 22 may be controllable and activatable by insertion of the associated partition 40. As set forth above, subscription to any one VA 22 may be controlled over network by associated DRM applications hosted in each partition 40 and/or in memory 500. Similarly, automated set up and/or installation and/or activation of VA services may be prompted by a user initially communicating with the UFI 70.

FIG. 4 shows an example embodiment of the present invention 10 in contemplation of specific hardware and software as presently seen in the art. It should be understood that FIG. 4 is intended as an example only and is not contemplated to be limiting to known or present hardware or applications or protocols or VAs, but rather to actualize and specialize in practicable example the embodiments previously described above.

UFI 70 in this example embodiment may be disposed in a wall, for example, as an outlet cover, faceplate, or other apparatus or device disposed in the home or office. UFI presents a touchscreen for user interaction, a microphone for audio capture, and at least one speaker for playback of a prompted response. UFI 70 is disposed in operational communication with bus 42 via switch 30. Microsoft®, Google®, and Amazon® VAs are installed into bus 42; in this example embodiment, via slotted engagement of memory hardware to create partitions upon which relevant applications are executable (as exemplified in FIG. 3). Such hardware is contemplated to include, for example, SIM cards, USB drives, direct drives, disks, or any other hardware upon which memory may be hosted and accessed when interconnected with bus 42. Switch 30 controls traffic between partitions 40 back to UFI 70 whereby multiple UFIs may be operatively couped to bus 42 to coordinate between and operationally communicate with VAs 22. VAs 22 may also push remotely into read/write memory partitions over network.

Thus, embodiments are contemplated herein that position multiple UFIs disposed throughout a building, for example, and/or in conjunction with a user across multiple devices and locations, whereby prompt signals are sensible and any VA available is accessible for use by a user. As shown in FIG. 5, for example, UFIs are disposed in each room of a house, integrated into walls and entertainment devices and peripheral devices, including, for example, smart TVs, computing devices, handhelds, peripherals, or specially devised standalone hardware that is installable in multiple ways into a user environment, including in a vehicle.

FIG. 6 illustrates a diagrammatic view of an example embodiment in illustration of the functions performed by the exemplary voice activated multiple format virtual assistant. In this example embodiment, each of a plurality of VAs is stored to a particular partition of memory, partitioned within, or uploaded and installed to, local memory operative within or coincident to the UFI. Partitions may be local or installable in actual units of corresponding hardware, such as illustrated in FIG. 2, 3, or 4, or hosted remote from the UFI over local area or even wide area networks. However, the steps as illustrated in FIG. 6 are, generally speaking, common to all embodiments. The user issues a wake word or other prompt signal, which is discerned at the UFI and attributed to a particular one of a plurality of VAs installed in the system. An API may discern the wake word and thence access the particular partition of memory to execute the corresponding VA in receipt of the wake word or prompt signal. Other VAs installed to the system remain in standby.

Once executed, the VA (here VA1) parses the inquiry signaled by the wake word or other prompt signal and data input (such as a typed query) and accesses data over network to configure and issue a response to the inquiry. It should be readily apparent that use of a different wake word or prompt signal would have enabled operation of a different VA. In some embodiments contemplated as within the scope of this disclosure, the API may access and execute each VA, and then configure the response based on the individual responses generated by each VA or enable an option for the user to toggle between, or prioritize, or select one of the VAs in preference to the others. Further, the API may synopsize or otherwise synthesize the responses configured by each VA.

FIG. 7 illustrates a front elevation view of an example embodiment of a UFI 70, installable into and, in multiple embodiments, throughout a user environment. In this example embodiment, UFI 70 is the approximate size of a tablet or small television. Individual VAs 22 are installable into particular ports disposed in UFI 70 as separate modules upon each of which is installed a unique VA for execution by UFI 70 in the manner described above. In this example embodiment, UFI 70 includes touchscreen 100 as a graphical user interface (GUI) as well as microphone (not shown) and speaker (not shown) whereby UFI 70 is able to return results visually by display as well as audibly via speaker. In some embodiments, a camera (not shown) may be included.

It is contemplated that this example embodiment is devised to be installable throughout a user environment and connected in network whereby a user has access to the voice activated multiple format virtual assistant 10 in each room of the house, for example, or at desired locations throughout any interior or, in some cases, exterior environment.

What is claimed is:

1. A voice activated multiple format virtual assistant running at least one processor, said voice activated multiple format virtual assistant comprising:
a user facing interface having at least a microphone and a speaker;
a memory disposed in networked communication with the user facing interface;
each of a plurality of virtual assistants running in either:
a dedicated partition of the memory; or
a separate readable memory connectable in communication with the memory;
wherein a prompt signal issued by a user triggers one of the plurality of virtual assistants and effectuates access to readable and playable data over network associated with the one of the plurality of virtual assistants in response to the prompt signal input by the user.

2. The voice activated multiple format virtual assistant of claim 1 wherein each of the plurality of virtual assistants is directly loadable into the user facing interface and executable therefrom by physically coupling the separate readable memory to a dedicated port in the user facing interface.

3. The voice activated multiple format virtual assistant of claim 1 wherein the user facing interface comprises a plurality of user facing interfaces configured in network across at least a local area network.

4. The voice activated multiple format virtual assistant of claim 3 wherein the plurality of user facing interfaces are configured in network across a wide area network.

5. The voice activated multiple format virtual assistant of claim 4 wherein at least some of the plurality of user facing interfaces are integrated with existing peripheral devices including smart phones, tablets, smart televisions, vehicular entertainment systems, and computing devices.

6. A voice activated multiple format virtual assistant running at least one processor, said voice activated multiple format virtual assistant comprising:
a user facing interface having at least a microphone, a speaker, and a touchscreen;
a memory disposed in networked communication with the user facing interface;
each of a plurality of virtual assistants running in either:
a dedicated partition of the memory; or
a separate readable memory connectable in communication with the memory;
wherein a prompt signal issued by a user triggers one of the plurality of virtual assistants and effectuates access to readable and playable data over network associated with the one of the plurality of virtual assistants in response to the prompt signal input by the user.

6. In a voice activated multiple virtual assistant running at least one processor, a method of running multiple virtual assistants from a single user facing interface, said method comprising the steps of:
configuring the user facing interface to actively listen by means of at least one microphone;
translating acoustic vibrations into electrical signals as data for processing and associating a particular pattern of electrical signals as data corresponding to a unique prompt signal that is specifically associated with at least one of the multiple virtual assistants;
when the unique prompt signal is discerned, accessing local random-access memory or remote random-access memory over network to execute the corresponding one of the multiple virtual assistants and relay the data thereto;
storing data captured immediately after receipt of the prompt signal;
executing code to communicate over network to relay the captured data as an inquiry to a remote server or database to read data for playback at the user facing interface in response to the inquiry.
